(19) United States
(12) Patent Application Publication
(10) Pub. No.: US 2007/0159420 A1
(43) Pub. Date: Jul. 12, 2007

(54) A Power LED Light Source

(75) Inventors: Jeff Jianhua Chen, Lawrence, KS (US); Xiaofang Suo, Lawrence, KS (US)

Correspondence Address: JEFF CHEN, 345 N. IOWA STREET, LAWRENCE, KS, 66044, US

(73) Assignees: Jeff Jianhua Chen, Lawrence, KS (US); Xiaofang Suo, Lawrence, KS (US)

(21) Appl. No.: 11/306,677

(22) Filed: Jan. 6, 2006

(51) Int. Cl. G09G 3/32; G09G 3/34; F21S 4/00

(52) U.S. Cl. 345/82; 345/84; 315/185 S

(57) ABSTRACT

Disclosed is a power LED light source that can be employed with different reflectors and other additional parts to form various power LED light units. Compared with the power LED light unit utilizing Luxeon LED packages and the like, the disclosed invention has the advantages of higher power, lower costs, better heat dissipation design and simpler optical design. The power LED light unit comprises of a base metal ring with multiple power LED dies mounted on it, one or more reflectors connected to the base metal ring, one or more extend metal rings connected to the base metal ring, a light unit base connected to the last extended metal ring, and a control circuit inside the metal rings. Such designed power LED light unit can emit light patterns such as parallel light pattern, non-parallel light pattern, and ring light pattern.

### DESCRIPTION

The invention relates to a power LED light source that can generate enough output power for general lighting purposes. The power LED light source can be employed with different reflectors and other additional parts to form various power LED light units. More particularly, the present invention may be used as a high power spotlight, floodlight, table light, etc.

LED lighting has been long known for its long life and ability to resist shock. It has been used as signaling sources for some time. Recent advances in the power LED technology have led to the Luxeon 5 watt LED package. Power LED package similar to Luxeon LED package found applications in special lighting such as flashlight, headlamp, etc. There have been attempts to utilize multiple power LED packages for general lighting purposes, but they were generally unsatisfactory because of the low power, high costs, poor heat dissipation and complexity of the optical system.

A power LED light source generally needs over ten watts to meet the general lighting standpoint. Such a light source requires more than ten of one-watt LED emitters or more than two of five-watt LED emitters. A Luxeon LED emitter typically measures about 8 mm in diameter. After mounted on the metal core PCB to form a Luxeon Star LED, it measures about 20 mm in diameter. Therefore, it is clear that a general lighting LED source built from multiple Luxeon Star LEDs generally ends up in a greater size, especially when the one-watt Luxeon star LED is used. To reduce the size, a five-watt Luxeon star LED is preferred as the building block. However, a five-watt Luxeon star LED is very expensive, and generates a huge amount of heat at a very small area. If the heat cannot be successfully removed, the junction temperature of the power LED dies will be too high, causing degradation or destruction of the LED. The design of the heat dissipation system is therefore a big challenge. In addition, a Luxeon star LED has a wide viewing angle of about 180 degrees. In order to efficiently employ multiple Luxeon star LEDs to general lighting, a complicated optical lens system will be necessary.

It is therefore desirable to provide a cheap and small power LED light source as the source for general lighting. It is further desirable that the power LED light source can efficiently conduct heat away from the power LED dies, and also that the optical design is simple. It is even further desirable that the power LED light source can be easily coupled with different reflectors to serve the general lighting purposes.

In accordance with the above principles, the present invention is designed so that the power LED light source is directly based on power LED dies, rather than on Luxeon Star LEDs and the like. This significantly reduces the complexity of the optical design and the package size. Also, this design increases the light-emitting surface area and allows the even distribution of heat generated by the power LED dies along a large area of the metal base.

The LED light source includes a base metal ring and several power LED dies evenly mounted around it. The power LED dies are electrically connected through gold wire in serial, in parallel, or in a combination of both. The preferable arrangement of power LED dies is when the maximum number of power LED dies are connected in serial under the designated source voltage. Such an arrangement minimizes the energy consumed on the components of a circuit other than the LEDs. The power LED dies and gold wires are protected by optical material such as silicone or epoxy. The power LED dies can be replaced with smaller LED dies in the event of lower power application, or with flip-chip LED sub-mounts in the event of higher power application. Furthermore, each individual power LED die can be replaced with a tight cluster of LED dies emitting different colors of light in the event of an application requiring multiple colors or white color.

A power LED light unit built from a power LED light source can further includes a metal cap optionally connected at the bottom of the base metal ring, a reflector screwed onto the end of the base metal ring opposite the metal cap, one or more extended metal rings threadedly connected to each other and screwed onto the end of the base metal ring opposite the metal cap, a light unit base that is formed to mechanically and electrically adapt to a socket connected to the extended metal ring, and a controlling circuit board located inside the metal rings.

The metal rings used for the presented power LED light unit are preferably made of copper. The surface where the LED chips are mounted on is preferably a metallized reflective surface. The metal cap preferably has a reflective surface and can be optionally designed to serve decorating purposes. Gaps between the base metal ring and the metal cap, and between the extended metal ring and the light unit base are necessary to allow airflow. The reflector can be in different shapes to direct light into desired light patterns. To obtain the best results, the reflector has a reflective parabolic inside surface, and the circle where all the LED dies are located can potentially overlap the circle where the focal points of the parabolic surface are located. In this preferred case, the light emitted from the front surface and three side surfaces of the LED dies are reflected by the parabolic reflector to result in parallel output light pattern, and even the light emitted from the side surface away from the reflector can be redirected by the reflective metal cap to the parabolic reflectors to result in parallel output light pattern.

The relative position of the base metal ring and the reflector is selectively adjustable for focusing and dispersing the LED beam as desired. An optical lens can be optionally attached to the reflector. It is also preferable that the focal points of the optical lens are on a circle that can overlap the circle where the focal points of the reflector are located. The reflector is not limited to the preferred parabolic reflector described above. For example, the reflector can be a reflective flat plate. Further, if two reverse-parabolic reflectors are screwed onto both ends of the base metal ring, the emitted light will be focused as a ring light, which is the desired pattern for emergency or warning lights.

The present power LED light unit has an excellent heat dissipation system. The LED dies or flip-chip sub-mounts are either welded or mounted on the base metal ring through thermally conductive organic or inorganic adhesives. The heat generated from the power LED dies is first drained to the base metal ring, and then spread to the extended metal rings that are in good thermal contact with the base metal ring. The airflow inside the metal rings facilitates the extraction of heated air away from the power LED light source.

The present power LED light unit can be applied either as replacement lamps or to a new LED lighting system. For an LED lighting system, the input voltage is an important issue. The LED die generally has a voltage drop of 2 to 4 volts. From the efficiency point of view, the LED dies are preferably connected in serial. From the safety point of view, the LED dies are preferably connected in parallel. Taking both efficiency and safety into account, 96 volts is preferred for outdoor lighting, 48 volts for indoor lighting, 12 volts for automobile application and the other voltages are for special lighting.

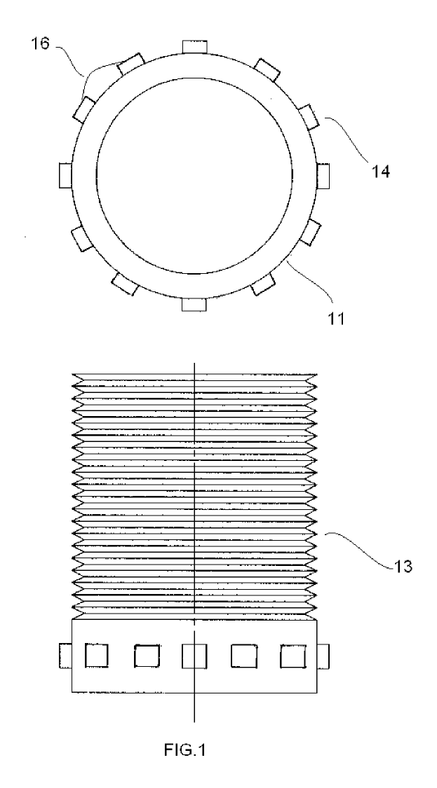

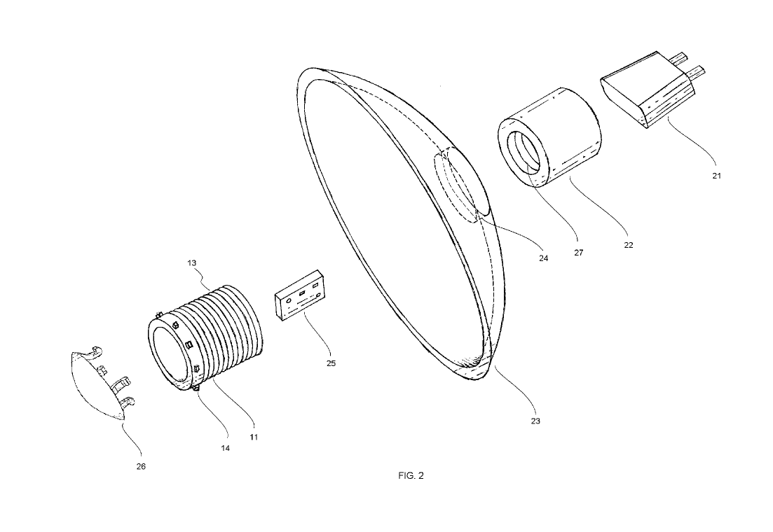

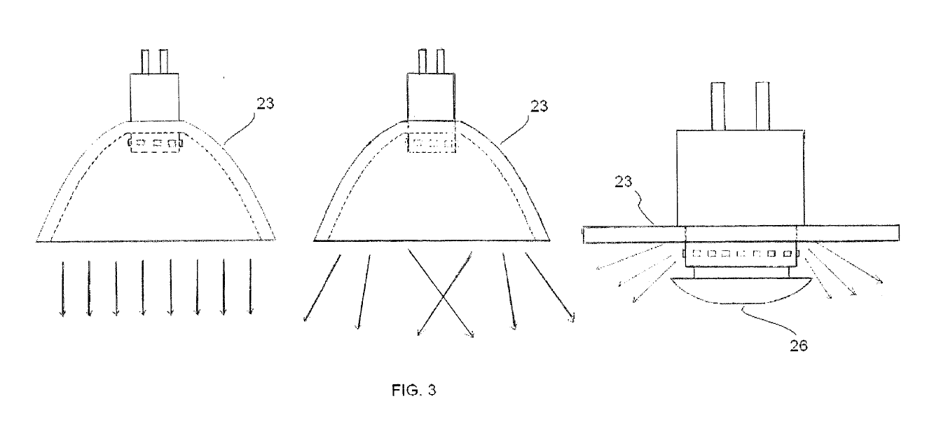

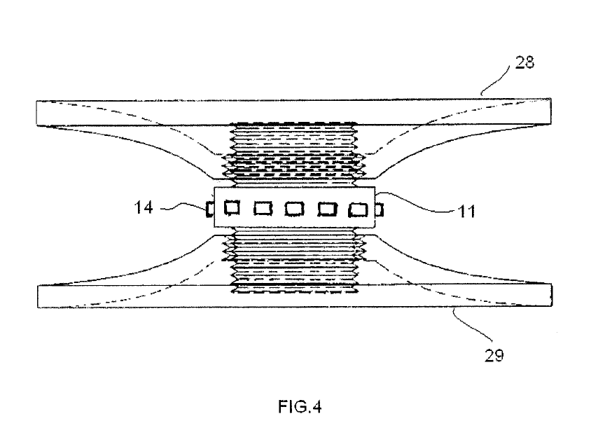

FIG. 1 is an illustration of the power LED light source. FIG. 2 is an exploded view of an example of a power LED light unit. FIG. 3 is an illustration of three typical light patterns from the power LED light unit. FIG. 4 is an illustration of ring light reflected by two reflectors coupled to both ends of the base metal ring. When an element or feature is shown in more than one figure, the same alphanumeric designation is used.

FIG. 1 is an illustration of the power LED light source. The power LED dies 14 are either evenly welded or mounted onto the base metal ring 11 through thermally conductive organic or inorganic adhesives. Power LED dies 14 are connected through gold wires 16 in a combination of both serial and parallel. The power LED dies 14 and gold wires 16 are protected by optical material that is not shown in FIG.1. The base metal ring 11 has external threads 13.

FIG. 2 is an exploded perspective view of the power LED light unit, illustrating the components of the LED light unit. The external threads 13 of the base metal ring 11 are to be connected with the internal threads 24 of the reflector 23. The internal threads 27 of the extended metal ring 22 are to be connected with the external threads 13 of the base metal ring 11. The light unit base 21 is engaged into the extended metal ring 22. The control circuit board 25 is to be slipped into the base metal ring. The metal cap 26 is to be connected to the end of the base metal ring 11 close to where the power LED dies 14 are mounted. The gaps between the base metal ring 11 and the metal cap 26, and also between the light unit base 21 and the extended metal ring 22 allow airflow surrounding the LED light unit.

FIG. 3 is an illustration of light patterns reflected by three examples of reflector 23. When the power LED dies are located on the focal point circle of a parabolic reflective surface, the reflected lights are in parallel. When the power LED dies are away from the focal point circle, the reflected lights are not in parallel. The reflector 23 can also take a shape of a flat plate.

FIG. 4 is an illustration of ring light reflected by two reflectors 28 and 29 connected to both ends of the base metal ring 11. The two reflectors together form a parabolic surface surrounding the power LED dies 14. In the case of the power LED dies 14 being located at the focal points of the parabolic surface, the reflected lights will form a well-focused ring light. Changing the shape of the both reflectors or the relative position of the LED dies 14 and the reflectors 28 and 29 will disperse the ring light accordingly.

What is claimed is:

1. The power LED light source comprises of:
a plurality of power LED dies; and
a base metal ring in various diameters depending on the number of power LED dies mounted on it.

2. The power LED light source of claim 1 wherein said power LED dies are evenly mounted around the said base metal ring, and said power LED dies are such arranged that the maximum numbers of said power LED dies are connected in serial under the designated source voltage.

3. The power LED dies of claim 1 can alternatively be any LED dies, flip-chip submounts, or a tight cluster of LED dies emitting different colors of lights.

4. The power LED light unit comprises of:
the power LED light source of claim 1;
one or more reflectors connected to the base metal ring;
one or more extend metal rings connected to the base metal ring;
a light unit base connected to the last extended metal ring; and
a control circuit inside the metal rings.

5. The power LED light unit of claim 4 wherein said LED light source is open-ended.

6. The power LED light unit of claim 4 wherein said reflector is a parabolic reflector with the focal point circle that may overlap the circle of said power LED dies.

7. The power LED light unit of claim 4 wherein said reflector may be any parabolic reflector.

8. The power LED light unit of claim 4 wherein said reflector may be a flat plate.

9. The power LED light unit of claim 4 wherein said reflectors may be two reflectors connected to both ends of said power LED light source, and the power LED dies are located on the focal point circle of the circular parabolic surface formed by the two reflectors.

10. The power LED light unit of claim 4 wherein said reflectors may be any two reflectors connected to both ends of said power LED light source.

11. The power LED dies of claim 3 are located on the circle of the focal points of said reflector to result in a parallel light pattern.

12. The power LED dies of claim 3 may be away from the focal point circle of the reflector to result in a non-parallel light pattern.

13. The power LED light unit of claim 4 may further include a cap with reflective surfaces at the bottom of the base metal ring.

14. The power LED light unit of claim 4 may further include an optical lens attached to the said reflectors.

15. The optical lens of claim 14 may have a focal point circle overlapping the focal point circle of said reflector of claim 4.
